(19) United States
(12) Patent Application Publication
(10) Pub. No.: US 2011/0244412 A1
(43) Pub. Date: Oct. 6, 2011

(54) MELTING FURNACE

(76) Inventors: Klaus Krüger, Hamburg (DE); Sascha Leadbetter, Munchen (DE); Detlef Rieger, Baldham (DE)

(21) Appl. No.: 13/139,701

(22) PCT Filed: Nov. 17, 2009
(86) PCT No.: PCT/EP2009/065317

§ 371 Date: Jun. 14, 2011

(30) Foreign Application Priority Data
Dec. 15, 2008 (DE) 1020080622567
Jul. 17, 2009 (DE) 1020090343539

(51) Int. Cl. F27D 21/00; H05B 7/02; C21C 5/52

(52) U.S. Cl. 432/32; 373/71

(57) ABSTRACT

In a melting furnace, a vibration inducer is installed on a furnace vessel, a sensor is arranged opposite or at another place on the furnace vessel and a signal recording and calculation unit is connected to the vibration inducer and the sensor. The melting process can be monitored and the progress of melting can be measured by measuring the signals of the vibration inducement after having passed through the interior of the furnace by this sensor and evaluating the signals of the signal recording and calculation unit. Thus, process-controlled, state-oriented regulation of the melting process can be carried out and the electric arc power is optimally matched to the respective state of the melting process. The signal of the sensor is preferably correlated with the excitation signal of the vibration inducer and/or conclusions are drawn about the melting process by combined evaluation of the vibration inducement and the measured vibration.

### CROSS-REFERENCE TO RELATED APPLICATIONS

This application is a U.S. National Stage Application of International Application No. PCT/EP2009/065317 filed Nov. 17, 2009, which designates the United States of America, and claims priority to German Application No. 10 2008 062 256.7 filed Dec. 15, 2008 and German Patent Application No. 10 2009 034 353.9 filed Jul. 17, 2009, the contents of which are hereby incorporated by reference in their entirety.

### TECHNICAL FIELD

The invention relates to a melting furnace and a method for operating the same.

### BACKGROUND

Melting furnaces and methods for operating the same are known, for example, from the German laid-open application DE 10 2005 034 378 A1 and the German patent specification DE 10 2005 034 409 B3.

In the production of steel in melting furnaces, the temperatures and hostile environment prevent the content of the furnace from being measured and characterized during the melting process. If, for example, an electric arc furnace is used for melting steel scrap of various kinds, the scrap melts within the effective range of the arcs (radiation), which are usually generated by three electrodes. Since, during the operation of the electric arc furnace, the arc length is usually kept constant, the arcs/electrodes bore into the scrap. By slipping down from the sides and collapses of the scrap, the entire scrap is gradually melted. This process is very inhomogeneous, in terms of both time and space, since the scrap filling may be very uneven and may contain fine scrap and heavy scrap with solid parts.

Since the progress of the melting cannot be observed through the closed furnace, in the case of known melting furnaces the electric operating point defined by the secondary outer conductor voltage and the setpoint current is predetermined by means of a fixed operating diagram. Such an operating diagram may, for example, fix the transformer stage and the impedance setpoint value of the electrode regulation in dependence on the melting time or the energy introduced. The electrode regulation may take place, for example, on the basis of the strand impedance, in order to achieve a constant arc length.

One disadvantage of fixed operating diagrams is that the electrical operating means are heavily loaded and must accordingly be designed for very high loads: if, for example, scrap collapses occur in the course of melting, the accompanying short-circuits between the electrodes may have the effect that the electrodes lift up quickly, which may cause the arc to be interrupted. This and the renewed striking of the arcs puts a considerable load on the electrical operating means.

A further disadvantage of fixed operating diagrams or operating programs for controlling an electric arc furnace is that, depending on the design, they either cannot fully utilize the available melting power or increased refractory wear and increased thermal losses have to be accepted.

### SUMMARY

According to various embodiments, a melting furnace can be provided that makes improved process control possible.

According to an embodiment, a melting furnace has at least one vibration inducer being installed on a furnace vessel, at least one sensor being arranged opposite or at another point of the furnace vessel and a signal recording and calculation unit is connected to the at least one vibration inducer and the at least one sensor.

According to a further embodiment, the signal recording and calculation unit can be suitable for correlating the signal of the sensor with the excitation signal of the vibration inducer. According to a further embodiment, the signal recording and calculation unit can be suitable for drawing conclusions about the melting process by combined evaluation of the vibration excitation and the measured vibration. According to a further embodiment, the at least one vibration inducer can be suitable for generating vibration pulses as external excitation, and the signal recording and calculation unit can be suitable for recording the travel time of the vibration pulses and/or the signal intensity of the measuring pulses measured by the sensor and, by evaluating the travel time and/or the signal intensity, for concluding the position of the material being melted, the type of material being melted, the distribution of the material being melted in the furnace vessel, any shielding of the inner vessel wall by the material being melted and/or the progress of the melting. According to a further embodiment, the vibration inducer can be suitable for generating a vibration pulse with a pulse duration of 10 milliseconds or shorter. According to a further embodiment, the vibration inducer can be suitable for generating a vibration frequency, which is changed continuously as a ramp. According to a further embodiment, the vibration inducer can be suitable for varying the vibration frequency in a range between 10 Hz and 20 kHz. According to a further embodiment, the signal recording and calculation unit can be suitable for forming a transmission function, which indicates the vibration transmission between the point of external excitation and the sensor located at the other point, and for drawing conclusions about the position of the material being melted, the type of material being melted, the distribution of the material being melted in the furnace vessel, any shielding of the inner vessel wall by the material being melted and/or the progress of the melting by evaluating the transmission function. According to a further embodiment, connected to the signal recording and calculation unit can be a regulating device, which can generate controlled variables for regulating the melting process. According to a further embodiment, each vibration inducer can be assigned an opposite sensor.

According to another embodiment, in a method for operating a melting furnace, an external excitation of the furnace vessel may take place by vibrations, a vibration produced by the external excitation can be measured at another point of the furnace vessel and conclusions can be drawn about the melting process by an evaluation of the vibration excitation and the measured vibration.

According to a further embodiment of the method, in the evaluation, the vibration and the external excitation can be correlated. According to a further embodiment of the method, a vibration pulse can be generated as external excitation, the travel time of the vibration pulse and/or the signal intensity of the measured measuring pulses is recorded as part of the vibration measurement at the other point and conclusions are drawn about the progress of the melting, the position of the material being melted, the type of material being melted, the distribution of the material being melted in the furnace vessel and/or any shielding of the inner vessel wall by the material being melted by evaluating the travel time and/or the signal intensity. According to a further embodiment of the method, a transmission function can be formed, indicating the vibration transmission between the point of external excitation and a sensor located at the other point, and conclusions can be drawn about the progress of the melting, the position of the material being melted, the type of material being melted, the distribution of the material being melted in the furnace vessel and/or any shielding of the inner vessel wall by the material being melted by evaluating the transmission function.

According to yet another embodiment, a signal recording and calculation unit for a melting furnace, can be configured for carrying out the method as described above.

### BRIEF DESCRIPTION OF THE DRAWINGS

The invention is explained in more detail below on the basis of exemplary embodiments; by way of example:

FIG. 1 shows an exemplary embodiment of a melting furnace in a schematic representation,

FIG. 2 shows the melting furnace according to FIG. 1 in a view from above,

FIG. 3 shows the melting furnace according to FIG. 1 in a view from the side,

FIG. 4 shows the propagation of vibrations in the melting furnace according to FIG. 1 and

FIG. 5 shows the variation over time of mechanical excitation pulses and the associated measuring pulses.

For the sake of overall clarity, the same reference signs are always used in the figures for identical or comparable components.

### DETAILED DESCRIPTION

It is thus provided according to various embodiments that at least one vibration inducer is installed on a furnace vessel, for example the furnace wall, at least one sensor is arranged opposite or at another point of the furnace vessel, for example another point on the furnace wall, and a signal recording and calculation unit is connected to the at least one vibration inducer and the at least one sensor.

It can be seen as a major advantage of the melting furnace according to various embodiments that, in the case of this furnace, the melting process can be monitored and the progress of the melting can be measured, by measuring the signals of the vibration inducement with the sensor after they have passed through the interior of the furnace and evaluating them with the signal recording and calculation unit. This makes it possible for example to carry out a process-controlled, state-oriented regulation of the melting process and match the arc power optimally to the respective state of the melting process. This may take place, for example, by prescribing the transformer and inductor stage and the three-phase current operating points and/or by means of preventive interventions in the electrode movement. It is also possible, for example, for the best charging times to be determined.

According to an embodiment, it is provided that the signal recording and calculation unit is suitable for correlating the signal of the sensor with the excitation signal of the vibration inducer and/or for drawing conclusions about the melting process by combined evaluation of the vibration excitation and the measured vibration.

The melting furnace can be operated particularly easily, and consequently advantageously, if there is connected to the at least one vibration inducer an activation unit, which can activate the vibration inducer in such a way that it generates vibration pulses as external excitation, and the signal recording and calculation unit is suitable for recording the travel time of the vibration pulses and/or the signal intensity of the measuring pulses measured by the sensor and, by evaluating the travel time and/or the signal intensity, for concluding the position of the material being melted, the type of material being melted, the distribution of the material being melted in the furnace vessel, any shielding of the inner vessel wall by the material being melted and/or the progress of the melting.

The activation unit and/or the vibration inducer are preferably suitable for generating vibration pulses with a pulse duration of 10 milliseconds, particularly preferably of 1 millisecond, or shorter.

Alternatively or in addition, the activation unit and/or the vibration inducer may be suitable for emitting a vibration frequency, which is changed continuously as a ramp. The activation unit and/or the vibration inducer are preferably suitable for varying the vibration frequency in a range between 10 Hz and 20 kHz.

It is also regarded as advantageous if the signal recording and calculation unit is suitable for forming a transmission function, which indicates the vibration transmission between the point of external excitation and the sensor located at the other point, and for drawing conclusions about the position of the material being melted, the type of material being melted, the distribution of the material being melted in the furnace vessel, any shielding of the inner vessel wall by the material being melted and/or the progress of the melting by evaluating the transmission function.

Preferably connected to the signal recording and calculation unit is a regulating device, which can generate controlled variables for regulating the melting process. With regard to the arrangement of the vibration inducers and the sensors, it is regarded as advantageous if each vibration inducer is assigned an opposite sensor.

According to other embodiments, in a method for operating a melting furnace, it is provided in this respect that an external excitation of the furnace vessel—for example at the furnace wall—takes place by vibrations, a vibration produced by the external excitation is measured at another point of the furnace vessel—for example another point on the furnace wall—and conclusions are drawn about the melting process by an evaluation of the vibration excitation and the measured vibration.

With respect to the advantages of the method according to various embodiments, reference should be made to the above statements in connection with the melting furnace according to various embodiments, since the advantages of the method correspond substantially to those of the melting furnace.

In the evaluation, the vibration and the external excitation are advantageously correlated.

According to an embodiment of the method, it is provided that a vibration pulse is generated as external excitation, the travel time of the vibration pulse and/or the signal intensity of the measured measuring pulses is recorded as part of the vibration measurement at the other point and conclusions are drawn about the progress of the melting, the position of the material being melted, the type of material being melted, the distribution of the material being melted in the furnace vessel and/or any shielding of the inner vessel wall by the material being melted by evaluating the travel time and/or the signal intensity. Vibration pulses with a pulse duration of at most 10 milliseconds, particularly preferably at most 1 millisecond, are preferably generated.

It may also be provided that a transmission function is formed, indicating the vibration transmission between the point of external excitation and a sensor located at the other point, and conclusions are drawn about the progress of the melting, the position of the material being melted, the type of material being melted, the distribution of the material being melted in the furnace vessel and/or any shielding of the inner vessel wall by the material being melted by evaluating the transmission function.

According to yet other embodiments, a signal recording and calculation unit for a melting furnace may be suitable for carrying out a method such as that described above.

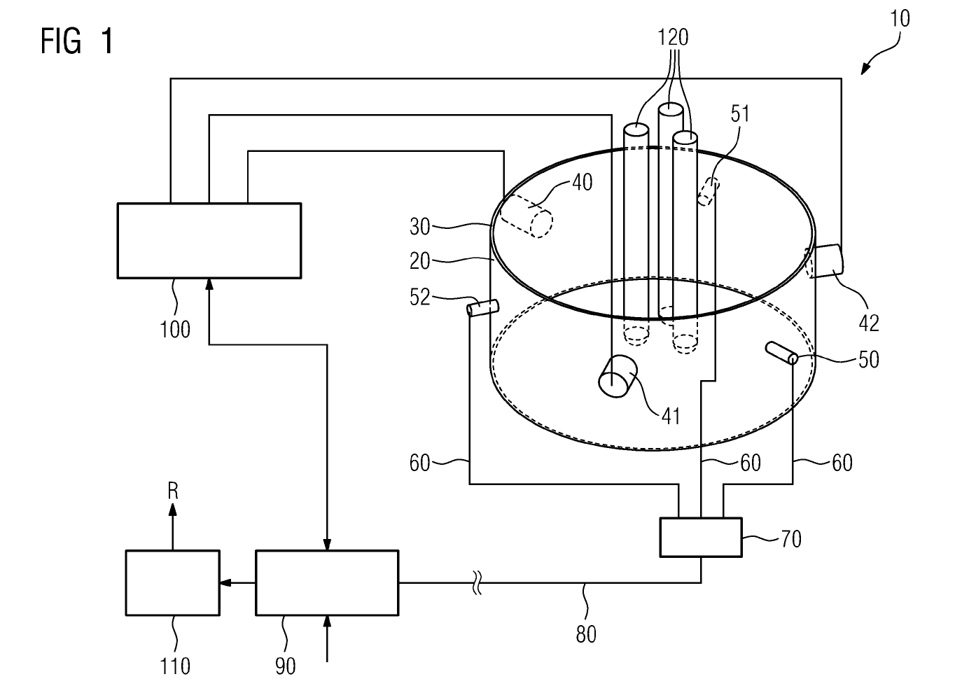

FIG. 1 illustrates a melting furnace 10, which has a furnace vessel 20. Three vibration inducers 40, 41 and 42 are arranged on the outside of the furnace wall 30 of the furnace vessel 20. The arrangement of the vibration inducers 40, 41 and 42 on the furnace wall 30 preferably takes place rotationally symmetrically with an angle of rotation of 120° and 240°.

The vibration inducers 40, 41 and 42 are preferably inertial vibration inducers or inertial inducers.

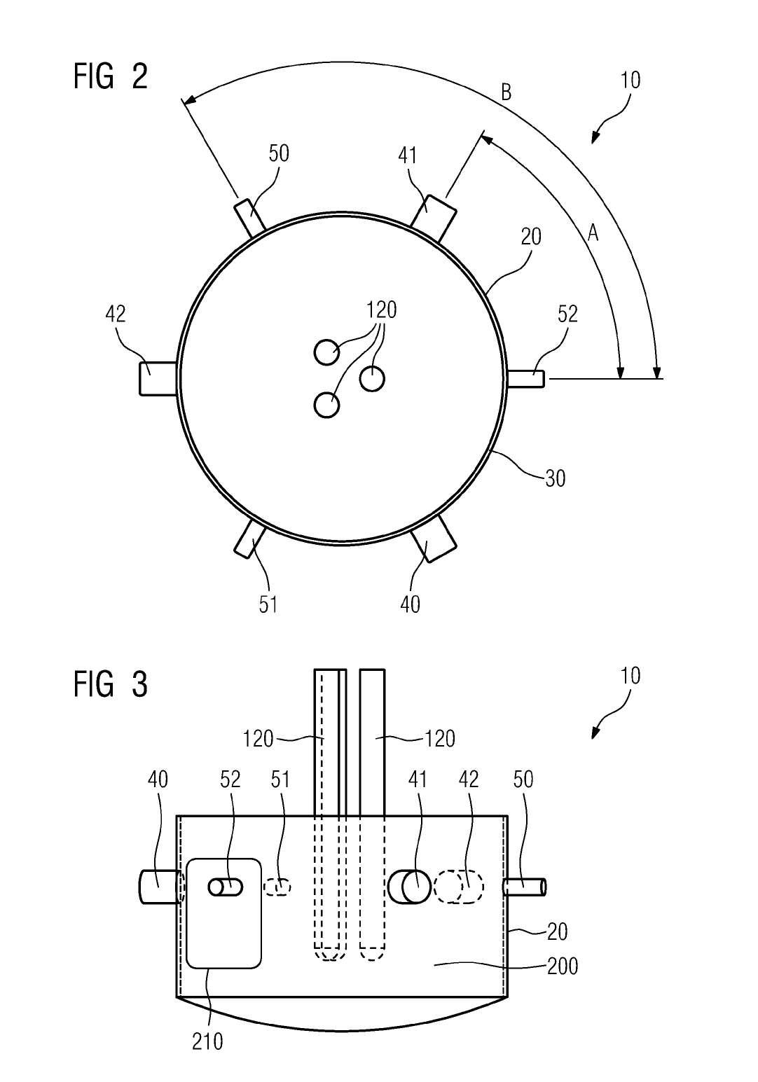

FIG. 1 also illustrates that three sensors 50, 51 and 52 are installed on the outside of the furnace wall 30 of the furnace vessel 20. The three sensors 50, 51 and 52 are likewise arranged rotationally symmetrically on the furnace wall 30, with an angle of rotation of 120° and 240°, as can be seen in FIG. 2 (B=120°, A=60°).

The arrangement of the sensors 50, 51 and 52 in relation to the vibration inducers 40, 41 and 42 is preferably chosen such that the sensors and vibration inducers lie opposite one another in pairs. So it can be seen in FIG. 1 that the sensor 50 lies opposite the vibration inducer 40, the sensor lies opposite the vibration inducer 41 and the sensor 52 lies opposite the vibration inducer 42. The three sensors 50, 51 and 52 are connected to an amplifier and converter unit 70 via protected lines 60, which are for example laid in cable ducts. Connected downstream of the amplifier and converter unit 70 via an optical waveguide 80 is a signal recording and calculation unit 90.

The signal recording and calculation unit 90 is also connected (for example via protected lines) to an activation unit 100, which is, for example, a vibration generator exciter, for example in the form of a power amplifier. The activation unit 100 is connected (for example via protected lines) on the output side to the three vibration inducers 40, 41 and 42 and activates them in dependence on control signals of the signal recording and calculation unit 90.

The signal recording and calculation unit 90 is additionally connected on the output side to a regulating device 110, which can generate controlled variables R for controlling the melting process in the melting furnace 10. The controlled variables R may be generated, for example, for a transformer, an inductor, electrode movements, charging times and/or the addition of media.

In FIG. 2, the arrangement of the three sensors 50, 51 and 52 and of the three vibration inducers 40, 41 and 42 is shown once again in a plan view. The symmetrical arrangement of the sensors and the vibration inducers can be seen, as well as the fact that the sensors lie spatially opposite the vibration inducers. Arranged in the middle of the furnace vessel 20 of the melting furnace 10 are three electrodes 120, with which the melting energy required for melting the material to be melted is fed into the furnace vessel 20.

In FIG. 3, the furnace vessel 20 is shown in a view from the side, in a transparent representation. The vibration inducer 40 and the assigned sensor 50 can be seen. In the middle of the furnace vessel 20, the three electrodes 120 can be seen. Furthermore, the molten material to be melted is schematically identified by a reference sign 200. It can also be seen that in the molten material to be melted 200 there is scrap of a higher density, which causes a sudden increase in density. The scrap of higher density is identified by the reference sign 210.

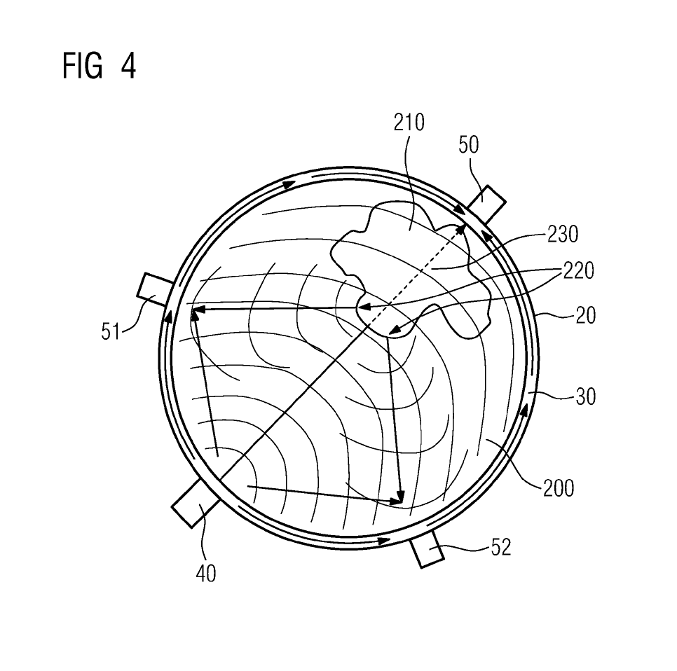

In FIG. 4, the propagation of vibrations is shown by way of example in the form of sound waves, which are generated by the vibration inducers 40. It can be seen that one component of the vibrations or sound waves is directed via the furnace wall 30 to the sensors 50, 51 and 52. The other component of the vibrations or sound waves passes through the material to be melted 200 directly or via reflections to the sensors 50, 51 and 52.

In FIG. 4 it can be seen that the scrap 210 of higher density leads both to an increased absorption of the vibrations or sound waves and to reflections of the vibrations or sound waves within the furnace vessel 20. The absorption is caused mainly in the interior 230 of the regions 210, and the reflections are caused mainly at the density boundaries 220.

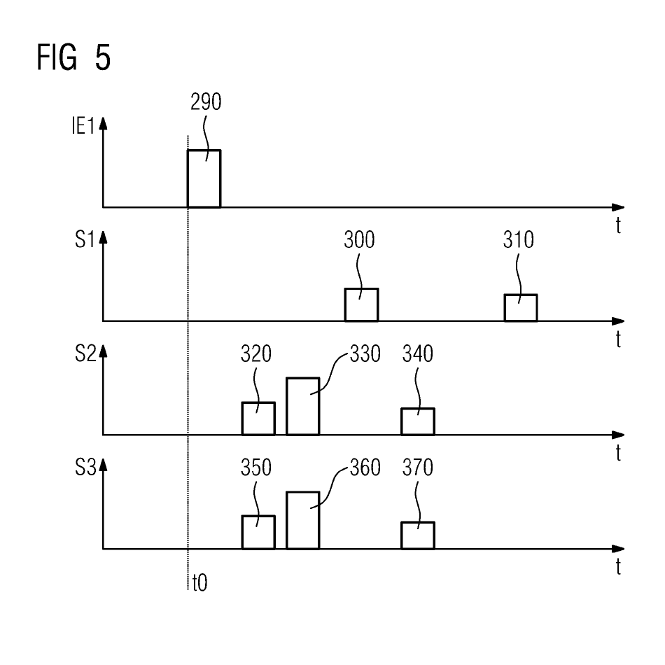

In FIG. 5, the variation over time of a vibration pulse 290 of the excitation signal IE1 is shown by way of example; the vibration pulse 290 is generated by the vibration inducer 40 at the point in time to.

In addition, FIG. 5 illustrates the measuring signals S1, S2 and S3, which are measured by the sensors 50, 51 and 52. It can thus be seen that, in the case of an excitation of the melting furnace 10 by the vibration pulse 290, the sensor 50 lying opposite the vibration inducer 40 measures two measuring pulses 300 and 310 (measuring signal S1). The sensor 51 measures a measuring signal S2, which has three measuring pulses 320, 330 and 340. The sensor 52 receives in the measuring signal S3, for example, likewise three measuring pulses, which are identified in FIG. 5 by the reference signs 350, 360 and 370.

By evaluation of the measuring pulses of the three sensors 50, and 52—with further consideration for the excitation signals of the vibration inducers 40, 41 and 42—the signal recording and calculation unit 90 can draw conclusions about the state of the process within the furnace vessel 20 and control the melting process correspondingly. This is to be described below in still more detail.

As already mentioned above, in the case of the melting furnace 10 according to FIGS. 1 to 4, an external excitation of the furnace vessel 20 by vibrations at a point of the furnace wall is combined with the recording of the vibrations or of the corresponding structure-borne sound on the opposite side or at any desired other point of the vessel. A combined or correlated evaluation of the vibration excitation and the measured vibrations or structure-borne sound signals allows conclusions to be subsequently drawn, inter alia about the content of the furnace, for example if sound reflections within the material to be melted allow the presence of density fluctuations to be concluded. The vibration inducers 40, 41 and 42, which are preferably installed on the furnace wall 30 in such a way that they are in a defined position in relation to the sensors 50, 51 and 52, are used for introducing the vibrations. The sensors 50, 51 and 52 may, for example, be formed by acceleration sensors and/or structure-borne sound sensors. To generate the vibrations, one, two or three, or even more, vibration inducers may be used. The activation of the vibration inducers takes place by means of the activation unit 100, which in turn is controlled by the signal recording and calculation unit 90.

The vibration produced on the furnace wall 30 is measured by the sensors 50, 51 and 52, and the signals are passed via the protected lines 60 into the central amplifier and converter unit 70 close to the furnace vessel 20 and are subsequently passed further via the optical waveguide 80 without interference over relatively long distances, which may be for example 100 m or more, into the signal recording and calculation unit 90. There, the signals are, for example, digitized with a sufficiently high sampling rate (for example 10,000 to 50,000 samples per second) and correlated by evaluation algorithms with the excitation signals of the vibration inducers 40, 41 and 42. Therefore, a combined evaluation of the vibration excitation and the measured structure-borne sound signals preferably takes place.

Thus, to obtain information on the scrap content and the distribution in the furnace, there are various possibilities for measurement and evaluation, which are to be explained by way of example below: According to a first variant, it is provided that the vibration inducers 40, 41 and 42 emit short pulses, which are preferably in each case shorter than one millisecond. FIG. 5 shows this by way of example by the excitation signal IE1 of the vibration inducer 50. If a number of vibration inducers are used, as may be the case in the exemplary embodiment according to FIGS. 1 to 5, the pulses are preferably emitted at time intervals, so that an exact assignment of the measuring signals to the vibration inducers 40, 41 and 42 is possible at any time. The sensors 50, 51 and correspondingly register the vibration pulses arriving at the furnace wall 30 with a time delay corresponding to the sound travel times (vibration travel times). This is schematically depicted in FIG. 4. There are various paths for the sound propagation. The sound can propagate through the furnace wall 30 and via the scrap (material to be melted) that is in the furnace. Reflections may then occur, as indicated for example in FIG. 4. The various sound propagation paths result in different travel times and signal intensities, both temporally and locally, for the individual sensors. By evaluation of the time intervals between the signal peaks (signal crests) and the intensity (height) of the signal peaks, the type and distribution of the scrap can be concluded from the signals of the sensors 50, 51 and 52 and the respective reference signals—relating to an empty furnace. For example, it is possible to calculate roughly a locational indication of the position of the heavy scrap, since heavy scrap has a higher density than normal scrap, and therefore leads to increased reflection and to increased or reduced (depending on frequency) absorption of the sound waves. Similarly, the shielding of the inner vessel wall, that is to say the inner side of the furnace wall 30 of the furnace vessel 20, by scrap can be quantified. According to another embodiment of the method, it is provided that the vibration inducers 40, 41 and 42 emit, and feed into the furnace vessel 20 via the furnace wall 30, a vibration frequency which is, for example, changed continuously as a ramp from a lower frequency to an upper frequency, or conversely from an upper frequency to a lower frequency. The lower frequency may be, for example, about 10 Hz and the upper frequency, for example, about 20 kHz.

If a number of vibration inducers 40, 41 and 42 are used, they are preferably operated one after the other. From the knowledge of the inducer vibration, that is to say the vibration caused by the vibration inducers, a sound transmission function H(ω) can be calculated for each of the three sensors 50, 51 and 52. This complex function will have for each of the three sensors 50, 51 and 52 a characteristic profile as a function of the frequency ω in dependence on the various scrap fillings in the interior of the furnace vessel 20, since different types of scrap and their distribution in the furnace vessel 20 influence the transport of sound differently, depending on the frequency, that is to say delay, attenuate and/or reflect sound differently. For this purpose, reference functions characteristic of various types of scrap, scrap fillings and respective progress of the melting are determined for the sound transmission function H(ω) in reference measurements to be carried out in advance. By comparison of the sound transmission functions H(ω) to be measured during the subsequent operation of the melting furnace 10 with the previously recorded characteristic reference functions H(ω), the furnace content at a particular time, such as the type of scrap and roughly the distribution and the progress of the melting, can then be determined. In the exemplary embodiment according to FIG. 1, the corresponding evaluation can be carried out by the signal recording and calculation unit 90, since it knows the measuring signals of the three sensors 50, 51 and 52 and the corresponding excitation signals, which are coupled into the furnace vessel 20 by the vibration inducers 40, 41 and 42 via the furnace wall 30.

The knowledge of the furnace content at a particular time and the knowledge of the distribution and the progress of the melting or the shielding of the vessel wall open up the possibility of optimized automatic operation. Provided for this purpose is the regulating device 110, which is connected on the input side to the signal recording and calculation unit 90 and generates on the output side the controlled variables R for controlling the melting process. The regulating device 110 preferably carries out a process-controlled, state-oriented regulation for an optimized melting process. For example, the transformer and inductor stages as well as the current operating points of the three phases, and possibly preventive interventions in the electrode movements, are regulated. In this way, by optimizing the energy input, a reduction of the specific energy requirement and the melting time can be achieved, as well as a reduction of vessel wear. Furthermore, the best charging times in each case can be determined.

To sum up, the melting furnace 10 explained by way of example, according to FIGS. 1 to 5, makes it possible to make the progress of the melting measurable and to carry out a process-controlled, state-oriented regulation, with which the arc power that is introduced into the melting furnace through the electrodes 120 is adapted optimally to the state of the process at a particular time.

What is claimed is:

1. A melting furnace, comprising
at least one vibration inducer which is installed on a furnace vessel,
at least one sensor which is installed on the furnace vessel, and
a signal recording and calculation unit which is connected to the at least one vibration inducer and the at least one sensor, wherein
the vibration inducer lies opposite the sensor in such a way that one component of the vibrations or soundwaves of the vibration inducer passes through the material being melted that is in the furnace vessel to the sensor,
the vibration inducer is designed in such a way that it generates as external excitation vibration pulses or a vibration frequency, which is changed continuously as a ramp,
the signal recording and calculation unit is designed in such a way that it records the travel time of the vibration pulses and/or the signal intensity of the measuring pulses measured by the sensor or forms a transmission function, which indicates the vibration transmission between the point of external excitation and the sensor lying opposite, and draws conclusions about the position of the material being melted, the type of material being melted or the distribution of the material being melted in the furnace vessel by evaluating the travel time and/or the signal intensity or by evaluating the transmission function.

2-4. (canceled)

5. The melting furnace according to claim 1, wherein the vibration inducer is suitable for generating a vibration pulse with a pulse duration of 10 milliseconds or shorter.

6. (canceled)

7. The melting furnace according to claim 1, wherein the vibration inducer is suitable for varying the vibration frequency in a range between 10 Hz and 20 kHz.

8. (canceled)

9. The melting furnace according to claim 1, wherein connected to the signal recording and calculation unit is a regulating device, which can generate controlled variables for regulating the melting process.

10. The melting furnace according to claim 1, wherein each vibration inducer is assigned an opposite sensor.

11. A method for operating a melting furnace, comprising the steps:
externally exciting the furnace vessel by vibrations,
measuring a vibration produced by the external excitation and
evaluating the vibration excitation and the measured vibration, wherein
one component of the vibrations or soundwaves of the vibration inducer is passed through the material being melted that is in the furnace vessel to a sensor lying opposite the vibration inducer,
vibration pulses or a vibration frequency, which is changed continuously as a ramp, being generated by the vibration inducer as external excitation,
at least one of the travel time of the vibration pulses and the signal intensity of the measuring pulses measured by the sensor being recorded or a transmission function being formed, indicating the vibration transmission between the point of external excitation and the sensor lying opposite, and conclusions being drawn about the position of the material being melted, the type of material being melted or the distribution of the material being melted in the furnace vessel by evaluating the travel time and/or the signal intensity or by evaluating the transmission function.

12-15. (canceled)

16. A melting furnace comprising:
at least one sensor, which is installed on a furnace vessel,
at least one vibration inducer generating external excitation vibration pulses or a vibration frequency, which is changed continuously as a ramp, and wherein the at least one vibration inducer is installed on the furnace vessel lying opposite the sensor such that a part of the vibrations or soundwaves generated by the vibration inducer passes through material being melted within the furnace vessel to the sensor, and
a signal recording and calculation unit, which is connected to the at least one vibration inducer and the at least one sensor and is operable to record at least one of the travel time of the vibration pulses and the signal intensity of the measuring pulses measured by the sensor or forms a transmission function, which indicates the vibration transmission between the point of external excitation and the sensor lying opposite, and further operable to draw conclusions about the position of the material being melted, the type of material being melted or the distribution of the material being melted in the furnace vessel by evaluating at least one of the travel time and the signal intensity or by evaluating the transmission function.

17. The melting furnace according to claim 16, wherein the vibration inducer is suitable for generating a vibration pulse with a pulse duration of 10 milliseconds or shorter.

18. The melting furnace according to claim 16, wherein the vibration inducer is suitable for varying the vibration frequency in a range between 10 Hz and 20 kHz.

19. The melting furnace according to claim 16, wherein connected to the signal recording and calculation unit is a regulating device, which can generate controlled variables for regulating the melting process.

20. The melting furnace according to claim 16, wherein each vibration inducer is assigned an opposite sensor.
